(19) United States
(12) Patent Application Publication
(10) Pub. No.: US 2026/0145306 A1
(43) Pub. Date: May 28, 2026

(54) FASTENER DRIVER TOOL

(71) Applicant: TECHTRONIC CORDLESS GP, Anderson, SC (US)

(72) Inventors: Jeremy Fedrigon, Greenville, SC (US); Trevor C. Fauss, Greenville, SC (US); Thomas Evatt, Six Mile, SC (US)

(21) Appl. No.: 18/957,126

(22) Filed: Nov. 22, 2024

(51) Int. Cl. B25B 15/02; B25B 23/00

(52) U.S. Cl. CPC B25B 15/02; B25B 23/0035; B25B 23/0042

(57) ABSTRACT

A fastener driver may include a first driver bit and a second driver bit. A fastener driver may include a handle coupled to the first driver bit, the handle and the first driver bit extending along a longitudinal axis, the handle including a base including a grip portion and a grip shank, a grip housing coupled to the grip shank, the grip housing at least partially defining a socket configured to removably receive the second driver bit, a key coupled to the grip shank, the key defining a socket aperture that at least partially defines the socket, wherein the socket extends along a second axis that is perpendicular to the longitudinal axis.

### FIELD

The present disclosure relates to fastener driver tools, and more particularly, a handheld manual fastener driver.

### BACKGROUND

Handheld manual fastener drivers, such as screw drivers, typically include a handle and a driver bit having a tool tip and a shaft extending from the handle to the tool tip. For certain applications, such as when fastening screws in a doorknob or a door lock, access to the screws can be obstructs such that the drive bit may only engage the screw at an off axis angle.

### SUMMARY

In some aspects, the disclosure relates to a fastener driver including: a first driver bit; a second driver bit; and a handle coupled to the first driver bit, the handle and the first driver bit extending along a longitudinal axis, the handle including a base having a grip portion and a grip shank; a grip housing coupled to the grip shank, the grip housing at least partially defining a socket configured to removably receive the second driver bit; and a key coupled to the grip shank, the key defining a socket aperture that at least partially defines the socket, wherein the socket extends along a second axis that is perpendicular to the longitudinal axis.

In some aspects, the disclosure relates to a fastener driver including: a first driver bit having an elongated shaft and a tip element; a second driver bit having a shorter length than the first driver bit; and a handle extending along a longitudinal axis from a first end to a second end, the first end coupled to the first driver bit such that the first driver bit extends along the longitudinal axis, the second end defining a socket configured to removably receive the second driver bit, the socket centrally defining a second axis that is perpendicular to the longitudinal axis, the handle including a front flat surface extending normal to the second axis and defining an opening communicating with the socket; a rear flat surface opposite from the front flat surface and extending normal to the second axis; and a grip portion located between the first driver bit and the front flat surface along the longitudinal axis, wherein the grip portion defines a first dimension measured along a direction of the second axis, wherein the handle defines a second dimension measured between the front flat surface and the rear flat surface along the direction of the second axis, and wherein the second dimension is less than the first dimension.

In some aspects, the disclosure relates to a fastener driver comprising: a first driver bit; a second driver bit; and a handle coupled to the first driver bit, the handle and the first driver bit extending along a longitudinal axis, the handle including a base including a grip portion and a grip shank; a grip housing coupled to the grip shank, the grip housing at least partially defining a socket configured to removably receive the second driver bit; wherein the socket extends along a second axis that is perpendicular to the longitudinal axis.

Other aspects of the disclosure will become apparent by consideration of the detailed description and accompanying drawings.

### BRIEF DESCRIPTION OF THE DRAWINGS

FIG. 1 is a perspective view of a handheld fastener driver according to an example of the disclosure.

FIG. 2 is a partially exploded perspective view of the handheld fastener driver of FIG. 1.

FIGS. 3 and 4 are perspective views of a handle of the handheld fastener driver of FIG. 1.

FIG. 5 is an exploded view of the handle of FIG. 3.

FIG. 6 is a cross-sectional view of the handheld fastener driver of FIG. 1, taken along line 6-6 of FIG. 1.

FIG. 7 is another cross-sectional view of the handheld fastener driver of FIG. 1, taken along line 7-7 of FIG. 1.

FIG. 8 is a perspective view of the handheld fastener driver of FIG. 1.

FIG. 9 is another perspective view of the handheld fastener driver of FIG. 1.

FIG. 10 is a first side view of the handheld fastener driver of FIG. 1.

FIG. 11 is a second side view of the handheld fastener driver of FIG. 1.

FIG. 12 is a first end view of the handheld fastener driver of FIG. 1.

FIG. 13 is a second end view of the handheld fastener driver of FIG. 1.

FIG. 14 is a front view of the handheld fastener driver of FIG. 1.

FIG. 15 is a rear view of the handheld fastener driver of FIG. 1.

FIG. 16 is a perspective view of the handle of FIG. 3.

FIG. 17 is another perspective view of the handle of FIG. 3.

FIG. 18 is a first side view of the handle of FIG. 3.

FIG. 19 is a second side view of the handle of FIG. 3.

FIG. 20 is a first end view of the handle of FIG. 3.

FIG. 21 is a second end view of the handle of FIG. 3.

FIG. 22 is a front view of the handle of FIG. 3.

FIG. 23 is a rear view of the handle of FIG. 3.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein is for the purpose of description and should not be regarded as limiting.

Features illustrated or described as part of one example can be used with another example to yield a still further example. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction (e.g., clockwise or counter-clockwise).

Benefits, other advantages, and solutions to problems are described below with regard to specific examples. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

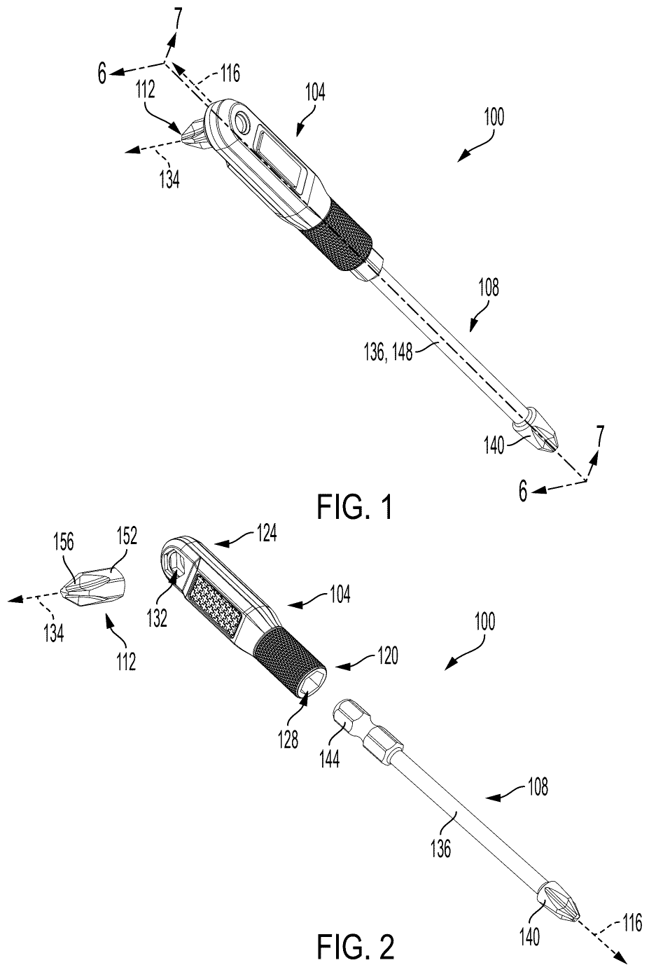

FIGS. 1 and 2 illustrate a handheld tool embodied as a fastener driver 100. The fastener driver 100 may be used to install or remove fasteners (not shown) for which access is difficult or limited, such as, e.g., a screw which secure doorknobs or door locks. The fastener driver 100 includes a handle 104, a first driver bit 108, and a second driver bit 112. The handle 104 is elongated along a longitudinal axis 116 and includes a first end 120 and a second end 124. The first end 120 defines a first socket 128 that selectively and removably receives and holds each of the first driver bit 108 or the second driver bit 112. The handle 104 also defines a second socket 132 adjacent the second end 124 which selectively and removably receives and holds either driver bit 108, 112. The first socket 128 is oriented along and centered about the longitudinal axis 116. The second socket 132 is oriented along and centered about a second axis 134 that is perpendicular to the longitudinal axis 116. The first driver bit 108 is elongated and is typically installed into the first socket 128 as shown in FIG. 1. The second driver bit 112 is much shorter than the first driver bit 108 and is typically installed into the second socket 132.

The first driver bit 108 includes an axial shaft 136 extending between a tip element 140 and a shank 144. The tip element 140 can include any type if bit (e.g., a Phillips bit, a slotted bit, a Pozidriv bit, a Torx bit, a square bit, or the like). The shaft 136 can have a smaller diameter or cross-sectional dimension than the tip element 140. The smaller diameter allows the first driver bit 108 to engage the screw more directly without rubbing against the doorknob. The first driver bit 108 can also include a non-marring sleeve 148 disposed about and covering the axially extending shaft 136. The non-marring sleeve 148 comprises a softer and less abrasive material than the axially extending shaft 136 and prevents the axially extending shaft 136 from marring the doorknob. The shank 144 is removably insertable into either of the first socket 128 or the second socket 132 in a non-rotatable manner.

The second driver bit 112 is substantially shorter than the first driver bit 108 and includes a shank 152 and a tip element 156. The shank 152 is removably insertable into either of the first socket 128 or the second socket 132 in a non-rotatable manner. The second driver bit 112 can have a total length, measured axially from an end of the shank 152 to an end of the tip element 156 of 20 millimeters or less. For example, the total length of the second driver bit 112 can be 15 millimeters.

In some examples, the handle 104 and the first driver bit 108 may be fixed such that the first driver bit 108 is non-removable or detachable from the handle 104. In such examples, the handle 104 does not include a first socket, and the second socket 132 is as described herein.

Each of the sockets 128, 132 may have any of a number of cross-sectional shapes and should match a corresponding cross-sectional shape of the shank 144, 152 of the installed driver bit 108, 112. In the illustrated example, each of the sockets 128, 132 has a hexagonal cross-sectional shape. In other examples, the sockets 128, 132 may alternatively have square, octagonal, triangular, or other cross-sectional shapes.

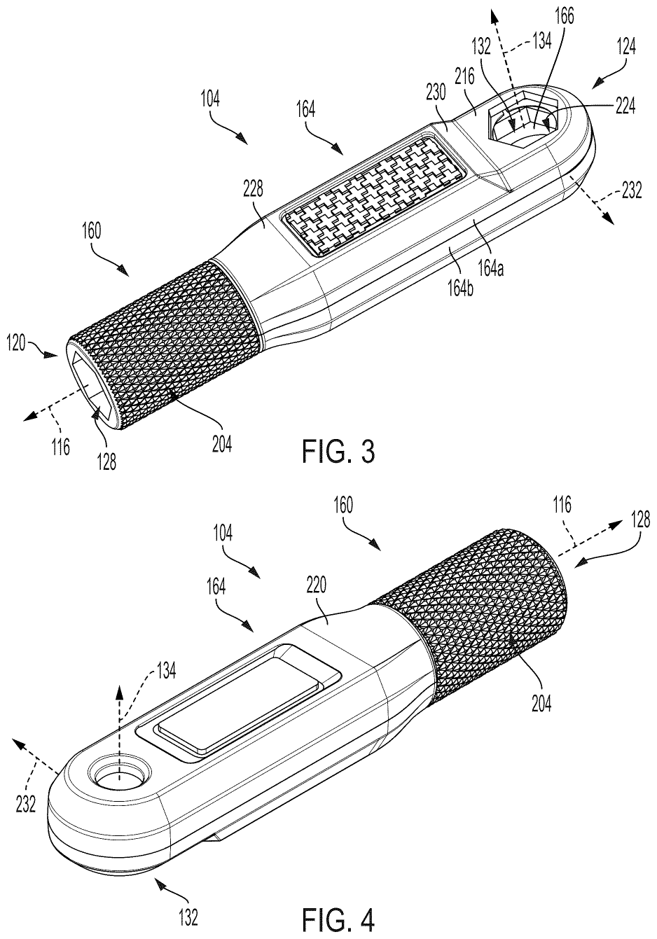

With reference to FIGS. 3-5, in the illustrated example, the handle 104 includes a base 160 and a grip housing 164. In the illustrated example, the base 160 is elongated and extends along the longitudinal axis 116. The base 160 is formed from a relatively hard and strong material such as metal. The base 160 defines the first socket 128. The grip housing 164 is formed from a resin material such as plastic, and includes two half housings 164a, 164b which couple together along a parting plane. The grip housing 164 defines at least a portion of the second socket 132. When the driver bit 108 or 112 is inserted into the second socket 132, the shank 144, 152 is directly held by the portion of the socket 132 defined by the grip housing 164. The grip housing 164 contacts the shank 144, 152 of the inserted driver bit 108, 112. More specifically, the grip housing 164 defines a stop surface 166 of the second socket 132 which limits insertion of the shank 144, 152.

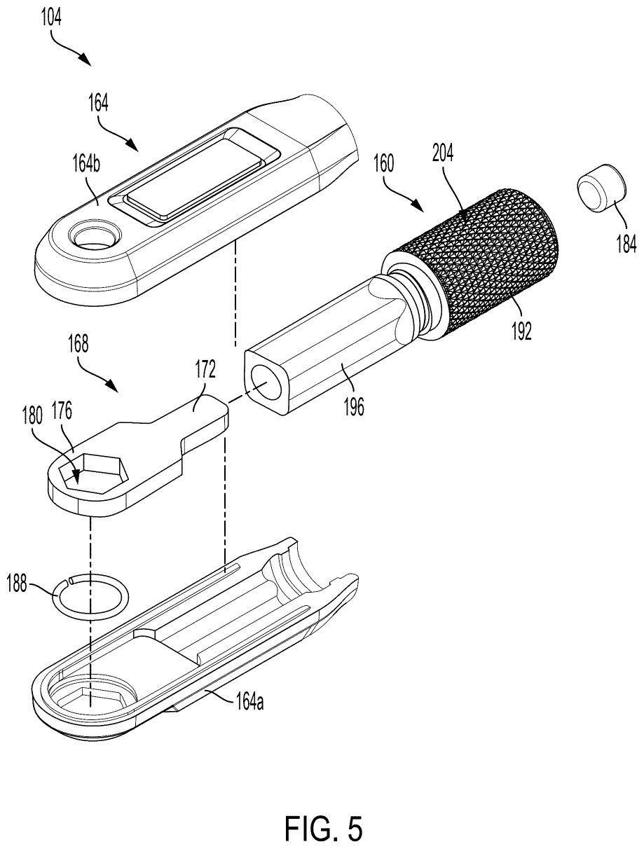

With reference to FIG. 5, the handle 104 also includes a bracket or a key 168 held within the grip housing 164. The key 168 includes a key shank 172 and a head 176 attached to the key shank 172. The head 176 defines a first aperture 180 and forms a portion of the second socket 132.

The handle 104 further includes a first retention element 184 and a second retention element 188. The first retention element 184 is located at the first socket 128 and engages the installed first driver bit 108 or second driver bit 112 to removably secure or retain the driver bit within the first socket 128. In the illustrated example, the first retention element 184 is a permanent magnet which magnetically engages the installed driver bit 108, 112 to hold the driver bit in the first socket 128. In other examples, the first retention element 184 can instead include, e.g., a C-clip, a detent element, a spring, or the like. Similarly, the second retention element 188 is located in the second socket 132 and engages the installed first driver bit 108 or second driver bit 112 to removably secure or retain the driver bit within the second socket 132. In the illustrated example, the second retention element 188 is a C-clip which clamps about the shank 144, 152 of the inserted driver bit 108, 112 to hold the driver bit in the second socket 132. In other examples, the second retention element 188 can instead include, e.g., a permanent magnet, a detent element, a spring, or the like.

With reference to FIGS. 5-7, the base 160 includes a grip portion 192 and a grip shank 196 extending away longitudinally from the grip portion 192. The grip portion 192 is cylindrical in shape and defines the first socket 128 in an axial end wall 200 thereof. In the illustrated example, the first socket 128 is a recess having a hexagonal cross-section corresponding to a hexagonal shape of the shank 144, 152 of the inserted driver bit 108, 112. The grip portion 192 defines a textured grip surface 204. The grip shank 196 has a substantially a square or rectangular profile that is received into a similarly shaped receptacle 208 defined by the grip housing 164 to rotationally fix the base 160 to the grip housing 164. In other examples, the grip shank 196 may have other cross-sectional profiles, such as octagonal, hexagonal, triangular, rectangular, or the like. The key 168 is coupled to the grip shank 196, which fixes the key 168 against rotation relative to the grip housing 164. Specifically, in the illustrated example, the grip shank 196 further defines a blind bore 212 which receives the key shank 172. The grip shank 196 thereby reinforces the key 168 against rotation relative to the grip housing 164 or the base 160 as torque is transferred from the handle 104 to the installed driver bit 108, 112 in the second socket 132. In other examples (not shown), the key 168 may instead be formed integrally with the base 160 as a single monolithic part.

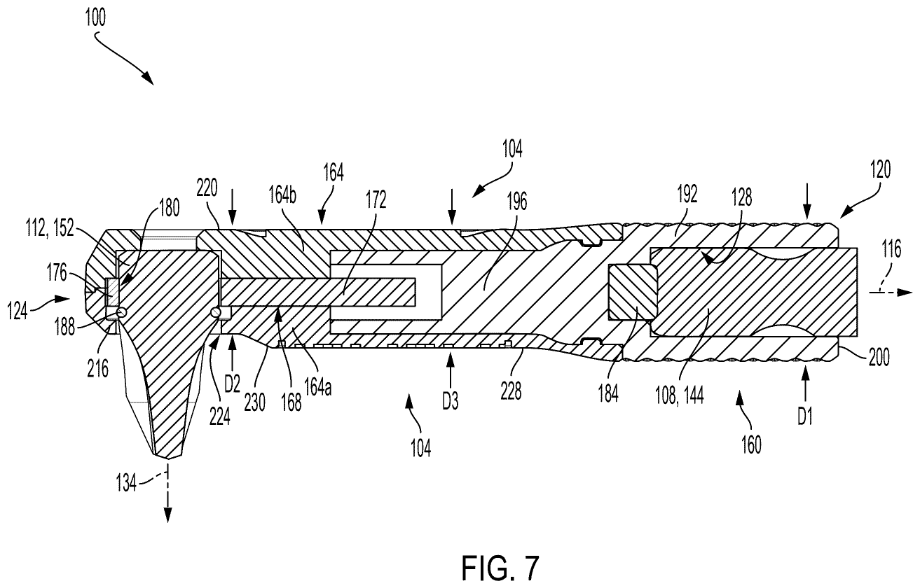

With reference to FIG. 7, the grip portion 192 of the handle 104, which defines the first socket 128, has a first dimension D1 that is measured parallel to the second axis 134. In the illustrated example, the first dimension D1 is a diameter of the grip portion 192. At the second end 124 of the handle 104, the grip housing 164 defines a front flat surface 216 and a rear flat surface 220. The front and rear flat surfaces 216, 220 are oriented normal to the second axis 134 and have a second dimension D2 therebetween, measured parallel to the second axis 134. The front flat surface 216 defines an opening 224 which communicates with the second socket 132. The second dimension D2 corresponds to a width of the second end 124 of the handle 104 where the second socket 132 is defined. The second dimension D2 is less than the first dimension D1. As such, the second end 124 has a width that is less than a width or diameter of the first end 120. This enables the second end 124 with the installed second driver bit 112 to narrowly access the fastener of the doorknob while the first end 120 provides a relatively larger gripping area for the user to manipulate the fastener driver 100. In particular, because the front and rear flat surfaces 216, 220 are oriented normal to the second axis 134, the second dimension D2, i.e., the width of the handle 104 at the second end 124, is minimized along a direction of the second axis 134 in the region of the second socket 132. This improves the ability of the fastener driver 100 to fit within tight spaces such as between the doorknob and the backplate of the door handle.

With continued reference to FIG. 7, the grip portion 192 further includes a second flat surface 228 located adjacent the front flat surface 216 and oriented normal to the second axis 134. The second flat surface 228 is also located between the front flat surface 216 and the grip portion 192, or the first end 120 of the handle 104, in the longitudinal direction. A step 230 is defined where the front flat surface 216 transitions to the second flat surface 228. A third dimension D3 is defined between the second flat surface 228 and the rear flat surface 220, measured parallel to the second axis 134. The third dimension D3 is less than the first dimension D1 and greater than the second dimension D2.

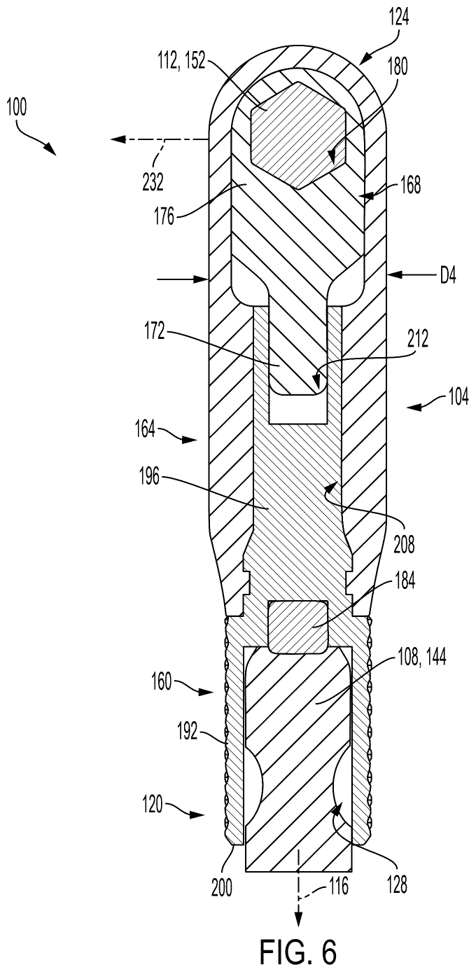

With reference to FIG. 6, the grip portion 192 further defines a fourth dimension D4 measured along a third axis 232 between opposite lateral sides of the grip housing 164. The third axis 232 extends perpendicular to the longitudinal axis 116 and to the second axis 134. For example, the fourth dimension D4 represents a width of the grip housing 164 in a direction normal to the longitudinal axis 116 and the second axis 134. The fourth dimension D4 is greater than the first dimension D1. As such, the grip housing 164 has a cross-sectional profile resembling an elliptical shape. Thus, the grip housing 164 provides a substantial gripping area for manipulating the fastener driver 100 while maintaining a low profile along the second axis 134.

In some examples, the handle 104 may further include a receptacle (not shown) that receives and stores the second driver bit 112 when the second driver bit 112 is not in use. For example, the grip housing 164 may define the receptacle, such as a pocket, which receives and holds the second driver bit second driver bit 112 in a recessed state below the front flat surface 216, the rear flat surface 220, and the second flat surface 228.

In operation, a user may use the fastener driver 100 to install or remove fasteners (not shown) for which access is difficult or limited, such as, e.g., a screw which secure door handles or door locks. For example, the user may use the first driver bit 108 installed in the first socket 128 to quickly begin tightening a screw, such as a doorknob screw. Although access to the screw may be limited and the first driver bit 108 may only be capable of engaging the screw at an off-axis angle, the required torque during initial tightening is low and thus the screw head is unlikely to strip. As the screw becomes tight, the user may then switch and engage the screw with the second driver bit 112 installed in the second socket 132. Because the second driver bit 112 is short and the handle 104 has a narrow profile in the region of the second socket 132, the second driver bit 112 can engage the screw on-axis without the doorknob interfering. Thus, the user can apply more torque to the screw via the second driver bit 112 (when compared to the torque applicable via the first driver bit 108) to complete tightening without stripping the screw head.

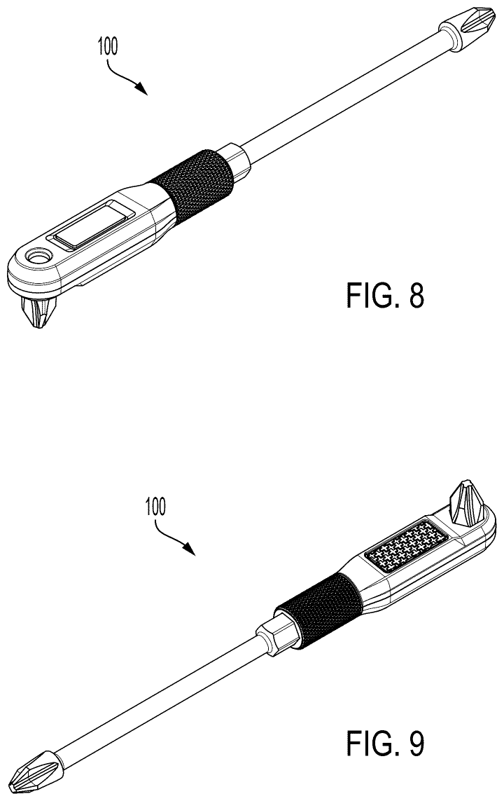

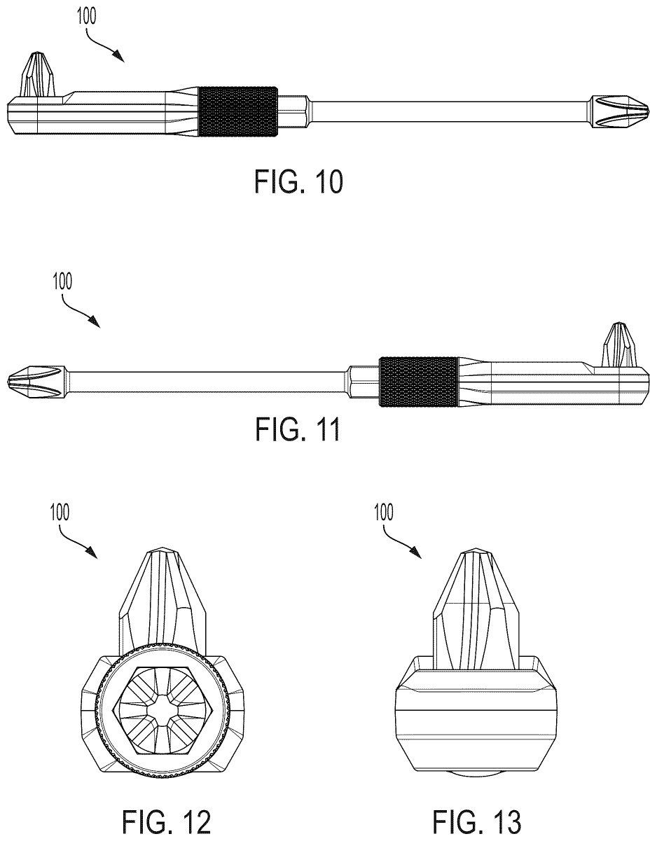

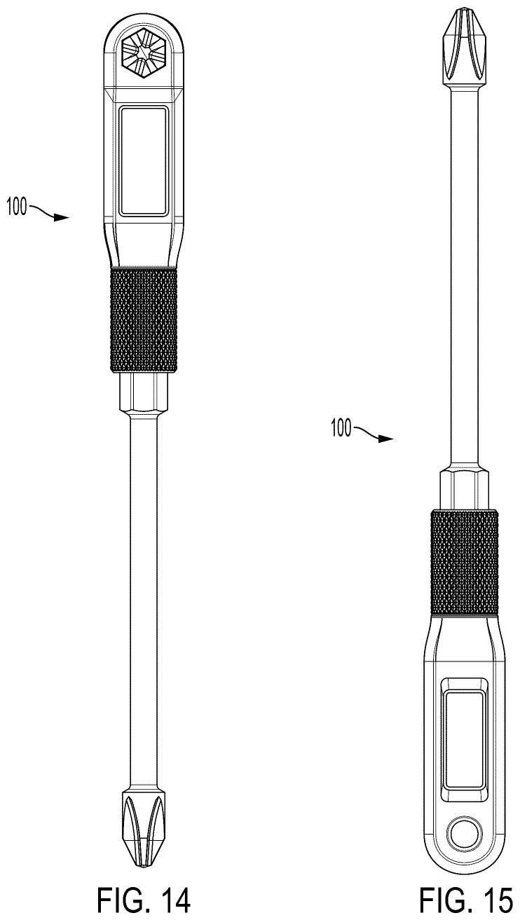

FIGS. 8-15 further illustrate the handheld fastener driver 100. In particular, FIGS. 8 and 9 illustrate perspective views of the fastener driver 100, FIGS. 10 and 11 illustrate side views of the fastener driver 100, FIGS. 12 and 13 illustrate end views of the fastener driver 100, and FIGS. 14 and 15 illustrate front and rear views of the fastener driver 100. is a perspective view of the handheld fastener driver of FIG. 1.

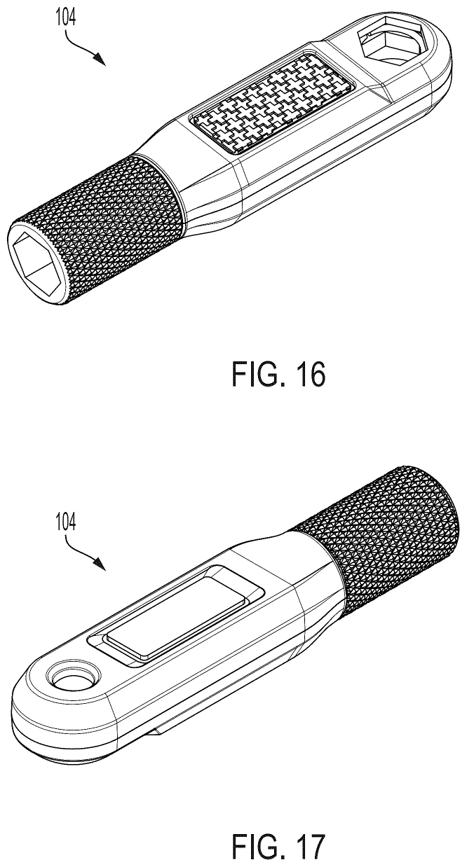

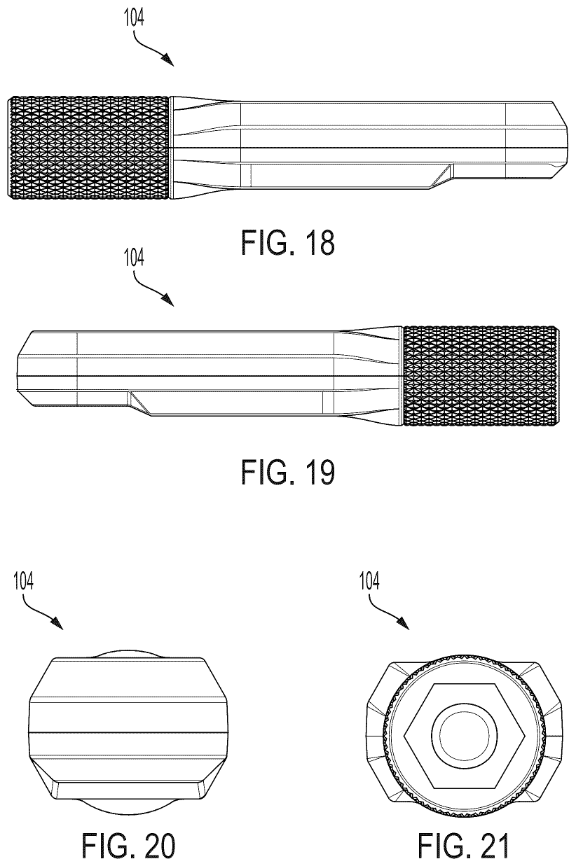

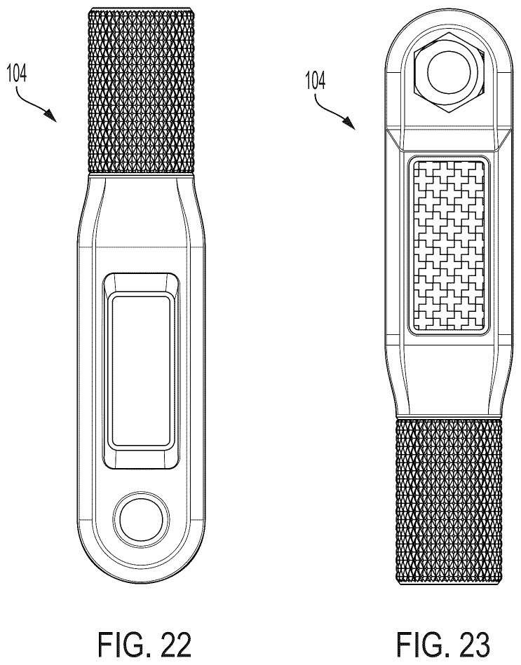

Likewise, FIGS. 16-23 further illustrate the handle 104. In particular, FIG. 16 and 17 illustrate perspective views of the fastener driver 100, FIGS. 18 and 19 illustrate side views of the handle 104, FIGS. 20 and 21 illustrate end views of the handle 104, and FIGS. 22 and 23 illustrate front and rear views of the handle 104.

Although the disclosure has been described in detail with reference to certain preferred examples, variations and modifications exist within the scope and spirit of one or more independent aspects of the disclosure as described.

Clause 1. A fastener driver comprising: a first driver bit; a second driver bit; and a handle coupled to the first driver bit, the handle and the first driver bit extending along a longitudinal axis, the handle including a base having a grip portion and a grip shank; a grip housing coupled to the grip shank, the grip housing at least partially defining a socket configured to removably receive the second driver bit; and a key coupled to the grip shank, the key defining a socket aperture that at least partially defines the socket, wherein the socket extends along a second axis that is perpendicular to the longitudinal axis.

Clause 2. The fastener driver of clause 1, wherein the key includes a key shank, and wherein the grip shank defines a blind bore that receives the key shank.

Clause 3. The fastener driver of clause 1, wherein the handle includes a first end and a second end that is opposite the first end along the longitudinal axis, and wherein the handle is coupled to the first driver bit at the first end, and wherein the second end includes the socket.

Clause 4. The fastener driver of clause 3, wherein the grip housing defines a front flat surface that defines an opening communicating with the socket, the front flat surface extending normal to the second axis, wherein the grip housing further defines rear flat surface opposite from the front flat surface and extending normal to the second axis, wherein the grip portion is located between the first driver bit and the front flat surface along the longitudinal axis, wherein the grip portion defines a first dimension measured along a direction of the second axis, wherein the grip housing defines a second dimension measured between the front flat surface and the rear flat surface along the direction of the second axis, and wherein the second dimension is less than the first dimension.

Clause 5. The fastener driver of clause 4, wherein the grip housing further defines a second flat surface adjacent the front flat surface and opposite the rear flat surface, the second flat surface being normal to the second axis, and wherein a step is defined at a transition between the front flat surface and the second flat surface.

Clause 6. The fastener driver of clause 5, wherein the grip housing further defines a third dimension measured between the second flat surface and the rear flat surface, wherein the third dimension is less than the first dimension, and wherein the third dimension is greater than the second dimension.

Clause 7. The fastener driver of clause 1, wherein the socket is a second socket, and wherein the grip portion defines a first socket configured to removably receive the first driver bit.

Clause 8. The fastener driver of clause 7, further comprising: a first retention element configured to retain the first driver bit within the first socket; and a second retention element configured to retain the second driver bit within the second socket.

Clause 9. A fastener driver comprising: a first driver bit having an elongated shaft and a tip element; a second driver bit having a shorter length than the first driver bit; and a handle extending along a longitudinal axis from a first end to a second end, the first end coupled to the first driver bit such that the first driver bit extends along the longitudinal axis, the second end defining a socket configured to removably receive the second driver bit, the socket centrally defining a second axis that is perpendicular to the longitudinal axis, the handle including a front flat surface extending normal to the second axis and defining an opening communicating with the socket; a rear flat surface opposite from the front flat surface and extending normal to the second axis; and a grip portion located between the first driver bit and the front flat surface along the longitudinal axis, wherein the grip portion defines a first dimension measured along a direction of the second axis, wherein the handle defines a second dimension measured between the front flat surface and the rear flat surface along the direction of the second axis, and wherein the second dimension is less than the first dimension.

Clause 10. The fastener driver of clause 9, wherein: the handle further defines a second flat surface adjacent the front flat surface and opposite the rear flat surface, the second flat surface being normal to the second axis; and a step is defined where the front flat surface transitions to the second flat surface.

Clause 11. The fastener driver of clause 10, wherein: the handle further defines a third dimension measured between the second flat surface and the rear flat surface; the third dimension is less than the first dimension; and the third dimension is greater than the second dimension.

Clause 12. The fastener driver of clause 9, wherein the handle includes: a base including the grip portion and a grip shank; a grip housing coupled to the grip shank, the grip housing at least partially defining the socket; and a key coupled to the grip shank, the key defining a socket aperture that at least partially defines the socket.

Clause 13. The fastener driver of clause 12, wherein the key includes a key shank, and wherein the grip shank defines a blind bore that receives the key shank.

Clause 14. The fastener driver of clause 12, wherein the grip housing includes a first half housing and a second half housing coupled along a parting plane.

Clause 15. The fastener driver of clause 9, wherein the socket is a second socket, and wherein the grip portion defines a first socket configured to removably receive the first driver bit.

Clause 16. The fastener driver of clause 9, wherein the grip portion defines a cylindrical grip surface.

Clause 17. The fastener driver of clause 9, further comprising a retention element configured to retain the second driver bit in the socket.

Clause 18. A fastener driver comprising: a first driver bit; a second driver bit; and a handle coupled to the first driver bit, the handle and the first driver bit extending along a longitudinal axis, the handle including a base including a grip portion and a grip shank; a grip housing coupled to the grip shank, the grip housing at least partially defining a socket configured to removably receive the second driver bit; wherein the socket extends along a second axis that is perpendicular to the longitudinal axis.

Clause 19. The fastener driver of clause 18, further comprising a key coupled to the grip shank, the key defining a socket aperture that at least partially defines the socket; wherein the key includes a key shank, and wherein the grip shank defines a blind bore that receives the grip shank.

Clause 20. The fastener driver of clause 18, wherein the socket is a second socket, and wherein the grip portion defines a first socket configured to removably receive the first driver bit.

Various features of the disclosure are set forth in the following claims.

What is claimed is:

1. A fastener driver comprising:
a first driver bit;
a second driver bit; and
a handle coupled to the first driver bit, the handle and the first driver bit extending along a longitudinal axis, the handle including
a base having a grip portion and a grip shank;
a grip housing coupled to the grip shank, the grip housing at least partially defining a socket configured to removably receive the second driver bit; and
a key coupled to the grip shank, the key defining a socket aperture that at least partially defines the socket,
wherein the socket extends along a second axis that is perpendicular to the longitudinal axis.

2. The fastener driver of claim 1, wherein the key includes a key shank, and wherein the grip shank defines a blind bore that receives the key shank.

3. The fastener driver of claim 1, wherein the handle includes a first end and a second end that is opposite the first end along the longitudinal axis, and wherein the handle is coupled to the first driver bit at the first end, and wherein the second end includes the socket.

4. The fastener driver of claim 3, wherein the grip housing defines a front flat surface that defines an opening communicating with the socket, the front flat surface extending normal to the second axis, wherein the grip housing further defines rear flat surface opposite from the front flat surface and extending normal to the second axis, wherein the grip portion is located between the first driver bit and the front flat surface along the longitudinal axis, wherein the grip portion defines a first dimension measured along a direction of the second axis, wherein the grip housing defines a second dimension measured between the front flat surface and the rear flat surface along the direction of the second axis, and wherein the second dimension is less than the first dimension.

5. The fastener driver of claim 4, wherein the grip housing further defines a second flat surface adjacent the front flat surface and opposite the rear flat surface, the second flat surface being normal to the second axis, and wherein a step is defined at a transition between the front flat surface and the second flat surface.

6. The fastener driver of claim 5, wherein the grip housing further defines a third dimension measured between the second flat surface and the rear flat surface, wherein the third dimension is less than the first dimension, and wherein the third dimension is greater than the second dimension.

7. The fastener driver of claim 1, wherein the socket is a second socket, and wherein the grip portion defines a first socket configured to removably receive the first driver bit.

8. The fastener driver of claim 7, further comprising:
a first retention element configured to retain the first driver bit within the first socket; and
a second retention element configured to retain the second driver bit within the second socket.

9. A fastener driver comprising:
a first driver bit having an elongated shaft and a tip element;
a second driver bit having a shorter length than the first driver bit; and
a handle extending along a longitudinal axis from a first end to a second end, the first end coupled to the first driver bit such that the first driver bit extends along the longitudinal axis, the second end defining a socket configured to removably receive the second driver bit, the socket centrally defining a second axis that is perpendicular to the longitudinal axis, the handle including
a front flat surface extending normal to the second axis and defining an opening communicating with the socket;
a rear flat surface opposite from the front flat surface and extending normal to the second axis; and
a grip portion located between the first driver bit and the front flat surface along the longitudinal axis,
wherein the grip portion defines a first dimension measured along a direction of the second axis,
wherein the handle defines a second dimension measured between the front flat surface and the rear flat surface along the direction of the second axis, and
wherein the second dimension is less than the first dimension.

10. The fastener driver of claim 9, wherein:
the handle further defines a second flat surface adjacent the front flat surface and opposite the rear flat surface, the second flat surface being normal to the second axis; and
a step is defined where the front flat surface transitions to the second flat surface.

11. The fastener driver of claim 10, wherein:
the handle further defines a third dimension measured between the second flat surface and the rear flat surface;
the third dimension is less than the first dimension; and
the third dimension is greater than the second dimension.

12. The fastener driver of claim 9, wherein the handle includes:
a base including the grip portion and a grip shank;
a grip housing coupled to the grip shank, the grip housing at least partially defining the socket; and
a key coupled to the grip shank, the key defining a socket aperture that at least partially defines the socket.

13. The fastener driver of claim 12, wherein the key includes a key shank, and wherein the grip shank defines a blind bore that receives the key shank.

14. The fastener driver of claim 12, wherein the grip housing includes a first half housing and a second half housing coupled along a parting plane.

15. The fastener driver of claim 9, wherein the socket is a second socket, and wherein the grip portion defines a first socket configured to removably receive the first driver bit.

16. The fastener driver of claim 9, wherein the grip portion defines a cylindrical grip surface.

17. The fastener driver of claim 9, further comprising a retention element configured to retain the second driver bit in the socket.

18. A fastener driver comprising:
a first driver bit;
a second driver bit; and
a handle coupled to the first driver bit, the handle and the first driver bit extending along a longitudinal axis, the handle including
a base including a grip portion and a grip shank;
a grip housing coupled to the grip shank, the grip housing at least partially defining a socket configured to removably receive the second driver bit;
wherein the socket extends along a second axis that is perpendicular to the longitudinal axis.

19. The fastener driver of claim 18, further comprising a key coupled to the grip shank, the key defining a socket aperture that at least partially defines the socket;
wherein the key includes a key shank, and wherein the grip shank defines a blind bore that receives the grip shank.

20. The fastener driver of claim 18, wherein the socket is a second socket, and wherein the grip portion defines a first socket configured to removably receive the first driver bit.
